(19) United States
(12) Patent Application Publication
(10) Pub. No.: US 2009/0127300 A1
(43) Pub. Date: May 21, 2009

(54) Personal extraction harness

(76) Inventor: RYAN D. STRAIGHT, PORTLAND, OR (US)

Correspondence Address: MARK S. HUBERT P.C., 516 SE MORRISON- SUITE 1200, PORTLAND, OR, 97214, US

(21) Appl. No.: 11/986,070

(22) Filed: Nov. 20, 2007

(51) Int. Cl. A62B 35/00

(52) U.S. Cl. 224/160; 182/6

(57) ABSTRACT

A casualty extraction strap for use in a tactical environment that is a durable, lightweight, adjustable, compact strap that allows the operator to effectively and rapidly extract a non-ambulatory casualty from a high-threat situation. Once the extraction strap is connected to an extraction loop sewn onto the neck of a flack jacket. The casualty's upper body is lifted off the ground, and his weight is centered between the legs of the operator, reducing drag and allowing maximum lifting capacity from the back, legs and hips of the rescuer. The operator maintains proper posture and the “hands free” design allows the operator to back away from the threat while maintaining engagement with the enemy.

### FIELD OF INVENTION

The present invention relates to an emergency extraction device, and more specifically to a harness or strap for extrication of a casualty from a high-threat tactical environment.

### BACKGROUND OF THE INVENTION

Modern warfare is often restricted to urban areas. Numerous factors complicate fighting in the urban landscape on both an operational and tactical level. Smaller tactical troop units are employed to maneuver through, and secure the confined terrain of cities and towns. These smaller attacking troop units must deal with limited fields of view (and fire) due to the three dimensional city environment, navigating narrow alleys, multiple story buildings, subway systems, and sewage systems. The complicated landscape of urban combat offers some distinct advantages to the weaker force, greatly enabling guerrilla style combat.

Rescue of fallen troops under these circumstances is extremely difficult and often needs to be initiated by just one soldier until a secure area can be reached for a larger scale rescue. It is imperative that a soldier be able to quickly engage a fallen soldier and safely maneuver the casualty. The rescuer needs to be able to secure the fallen while maintaining the requisite degree of mobility and dexterity to ensure not only the victim's survival but also his own.

The prior art extraction harnesses have several drawbacks. First, they are not designed to minimize the movement friction by partially raising the injured person, second they are not designed to allow the rescuer full use of his own arms to operate his weapon, third they are not designed to allow for the ease of cornering, fourth they are not operable from a position whereby the rescuer can view the combat field directly behind the injured person, fifth they are not designed to allow the most ergonomic, strongest position for lifting leverage as would be needed by a rescuer of small physical stature.

### SUMMARY OF THE INVENTION

In accordance with the preferred embodiment of this invention, an object of the present invention is to provide an improved casualty extraction strap that will allow maximum, ergonomic lifting capacity, by partially raising the casualty and centering the casualty's weight between the extractor's legs.

It is another object of this invention to provide an improved casualty extraction strap that will attach to the neck strap of a conventional flack jacket of a casualty and raise the injured soldier to a sitting position thereby reducing the friction created when dragging the injured soldier as well as minimizing the infiltration of dirt and debris in upper body open wounds.

It is a further object of this invention to provide a “hands free” extraction strap which allows the extractor to back away from the situation with the casualty in tow, maintain the line sight, and maintain his weapon for defense.

It is still a further object of this invention to provide a compact extraction strap that can be easily stored in its own carrying case on a soldier's flack jacket or backpack.

It is still a further object of this invention to provide an adjustable extraction strap to allow for the maximum lifting power and minimal potential for injury of the extractor by the ergonomic placement of the weight and the strap's use of the rescuer's legs and hips to lift.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1. is a front view of the extraction harness;

FIG. 2. is a perspective view of the extraction strap in its stowed configuration;

FIG. 3. is a perspective view of the extraction strap in its stowed configuration within its carrying case;

FIG. 4. is a front view of the extraction harness operatively positioned on the rescuer;

FIG. 5. is a rear view of a body armor, illustrating a conventional extraction loop; and

FIG. 6. is a side view of an rescuer employing the extraction harness on a casualty.

### DETAILED DESCRIPTION

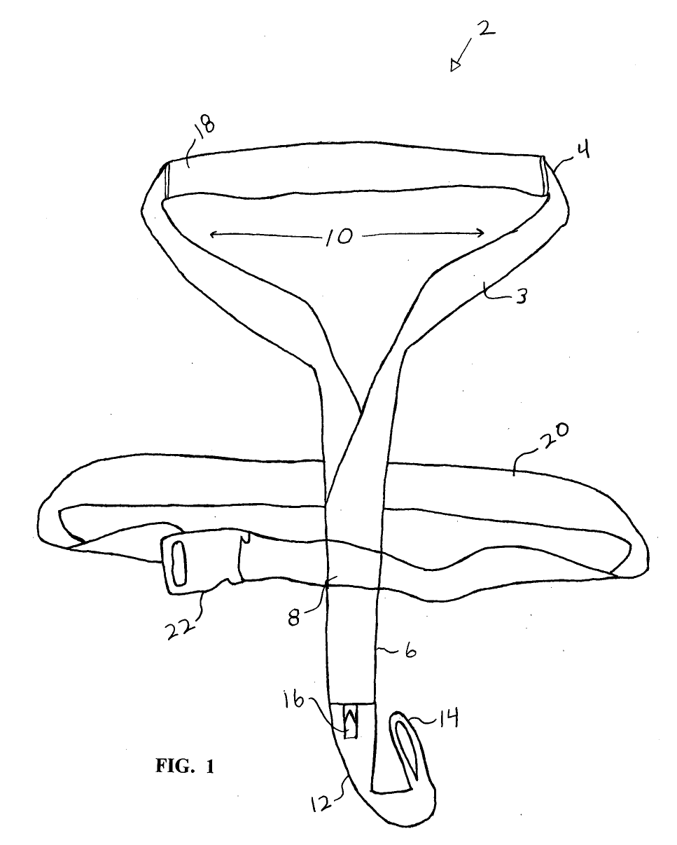

Referring now to FIG. 1, the preferred embodiment of the personal extraction harness 2 comprises a first linear fabric strap 3 having a distal end 4 and a proximate end 6 mechanically affixed atop one another at an overlap junction 8 so as to form a flexible enclosure 10 having a reinforced, double layer thickness tail member 12 extending beyond said junction 8 and terminating in a loop 14. A rigid hook 16 adapted and sized for the secure engagement of loop 14 is mechanically affixed onto said tail member 12. For added comfort the first linear fabric strap 3 has a padded cover 18. The hook has rear arms or an attachment plate designed for the mechanical securement of the hook 16 onto tail member 12 as would be well known to one skilled in the art. An example would be an enlarged version of a conventional brassier clasp. This works particularly well with stitching affixation.

A second linear fabric strap 20 formed into a belt and mechanically affixed substantially perpendicular to said first strap 3 at said overlap junction 8 is adjustable in width and has a releaseable clasp 22 thereon, adapted for the releaseable engagement of said belt about the waist or hips of a person. Although in the preferred embodiment the releaseable clasp 22 is capable of performing both the release and size adjustment functions, it is well known in the industry that this could be accomplished buy a separate belt release clasp and separate belt tensioner.

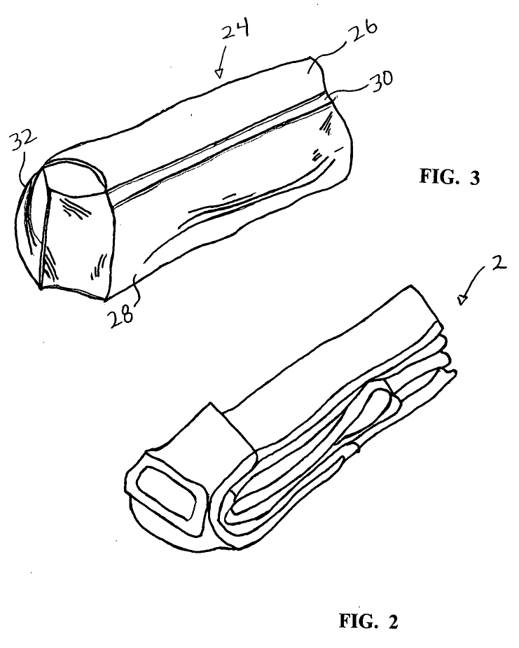

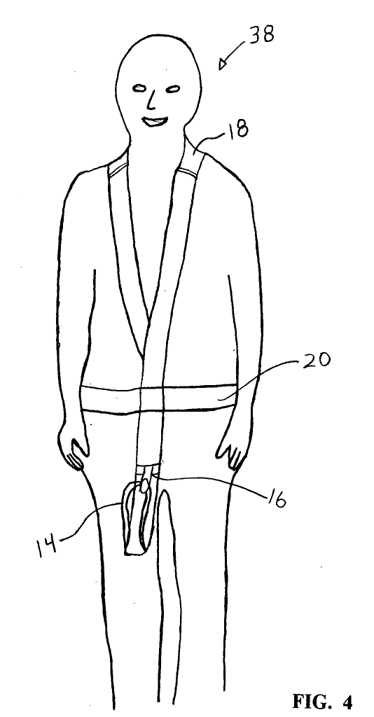

FIG. 2 illustrates the extraction harness in its compacted configuration, and FIG. 3 illustrates the extraction harness in its compacted configuration stowed in its carrying pouch 24. The carrying pouch 24 can be made of any durable lightweight flexible material preferably waterproofed nylon or other suitable polymer fabric, with the top portion 26 secured to the bottom portion 28 with hook and loop fasteners 30. While FIG. 3. illustrates the hook and loop fastener, any common mechanical fabric fasteners could be used such as zippers, dome fasteners, buttons, and belt clips. Additionally, the carry pouch 24 has two nylon straps 32 (only one is visible in FIG. 3) for securing the carrying pouch 24 onto a strap member of a soldier's military garb.

FIG. 4 illustrates the extraction harness 2 operatively positioned on a rescuer 38. The padded cover 18 is visible around the rescuer's neck and shoulders; the second linear fabric strap 20 is adjustably tensioned around, and rests on the rescuer's hips, with the loop 14 of the tail member 12 is engaged with the hook 16.

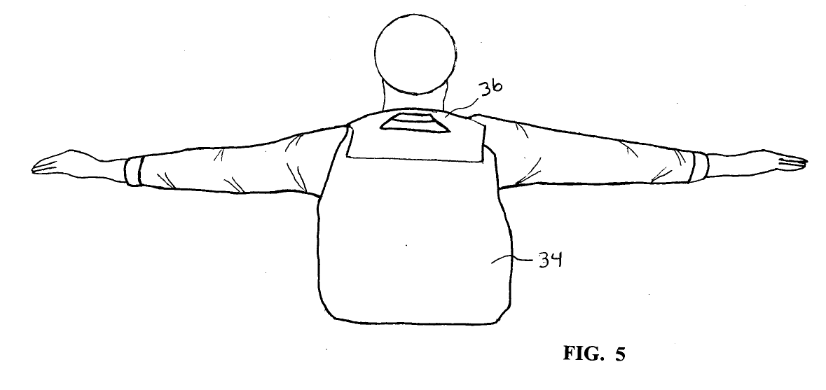

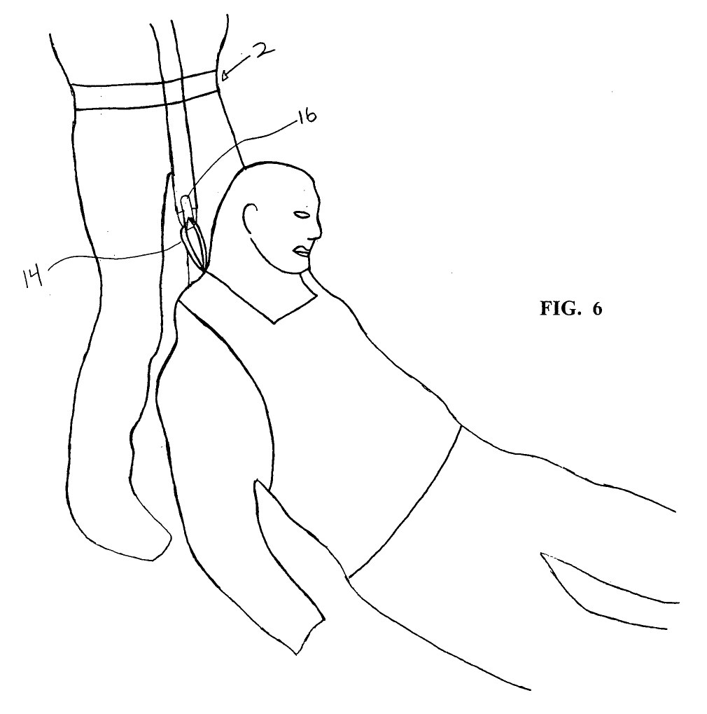

FIG. 5. illustrates a back view of a casualty's conventional flack jacket 34. The strap member or handle 36 is visible. The loop 14 is fitted through the opening of the handle 36 (the space between the handle and the flack jacket) and looped back over onto itself for engagement with the hook 16 (not illustrated).

FIG. 6. illustrates a rescuer employing the extraction harness 2 on a casualty. The loop 14 is engaged with the hook 16, and the casualty's upper body is lifted from the floor. It can be seen that from this advantageous positioning of the rescuer and the casualty, the rescuer's hands are free to operate firepowerer while backing out the casualty from the point of extraction. It is to be noted that this allows the rescuer to keep the rescuer in the line of vision at all times, turn tight corners without problems and utilize a synergistic combination of the larger muscles of the body to drag the casualty to a safety.

The preferred method of mechanically affixing the first linear fabric strap to itself, the belt to the strap, the loop to the tail member and the hook to the tail member is stitching, although a plethora of other methods may be used such as adhesive bonding, polymer seal welding, pop rivets, or other fattening means.

It is known that a different clasp or hooking system may be utilized in place of hook illustrated. However extensive testing has shown that the preferred embodiment hoop and loop is simple to use, quick to engage and failure free. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Having thus described the invention, what is claimed as new and desired to secure by Letters Patent is as follows:

1. An extraction harness for the physical relocation of a non-ambulatory casualty comprising:
a first linear fabric strap having a distal end and a proximate end mechanically affixed atop one another at an overlap junction so as to form a flexible enclosure having a tail member extending beyond said junction and terminating in a loop;
a hook mechanically affixed onto said tail member located between said loop and said junction;
a second linear fabric strap formed into an belt and mechanically affixed substantially perpendicularly to said first strap at said overlap junction.

2. The extraction harness of claim 1 wherein said belt is adjustable in width and has a releaseable clasp thereon, adapted for the releaseable engagement of said belt about the waist or hips of a person.

3. The extraction harness of claim 1 wherein said first linear fabric strap has a padded cover thereon.

4. The extraction harness of claim 2 wherein said first linear fabric strap has a padded cover thereon.

5. The extraction harness of claim 4 wherein said hook is a rigid hook adapted to engage and retain said loop once said loop and tail member have been partially passed through an extraction strap of a flack vest or other piece of military garb.

6. The extraction harness of claim 4 further comprising a mechanically closeable carrying pouch adapted for the securable retention onto a strap member of a soldier's military garb.

7. The extraction harness of claim 4 further comprising a hook and loop fastening carrying pouch adapted for the securable retention onto a strap member of a soldier's military garb.

8. The extraction harness of claim 1 wherein said mechanical affixation is by stitching.

9. The extraction harness of claim 2 wherein said mechanical affixation is by stitching.

10. An emergency extraction harness for the extraction of a non-ambulatory casualty from a tactical environment comprising:
a first substantially non-stretchable fabric strip having a first end and a second end that are mechanically joined so as to form a hoop with a unitary strap that contains a hook extending therefrom and terminates in a loop;
a second substantially non-stretchable fabric belt mechanically fastened to said unitary strap.

11. The emergency extraction harness of claim 9 wherein said belt further comprises an adjustable releaseable member.

12. The emergency extraction harness of claim 10 wherein said fabric is a high tensile strength polyester strap material.

13. The emergency extraction harness of claim 10 wherein said hook is adapted for engagement with said loop.

14. The emergency extraction harness of claim 9 wherein said hoop and said belt work in unison to distribute any tension force transmitted through said hook onto said unitary strap when said hoop is placed around a rescuer's neck and said belt is placed around said rescuer's waist.

15. The emergency extraction harness of claim 10 further comprising an adjustable padding cover over said non-stretchable fabric strip.

16. The emergency extraction harness of claim 9 wherein said first end and said second ends, said fabric belt and said unitary strap, said hook and said unitary strap and said loop are all connected or formed by stitching.
